(19) United States
(12) Patent Application Publication
(10) Pub. No.: US 2002/0109585 A1
(43) Pub. Date: Aug. 15, 2002

(54) Apparatus, method and system for range extension of a data communication signal on a high voltage cable

(76) Inventor: Lelon Wayne Sanderson, Fayetteville, TN (US)

Correspondence Address: Curtis W. Dodd, 2803 Bentley Street, Huntsville, AL, 35801, US

(21) Appl. No.: 10/077,074

(22) Filed: Feb. 15, 2002

Related U.S. Application Data
(60) Provisional application No. 60/269,191, filed on Feb. 15, 2001.

(51) Int. Cl. H04M 11/04

(52) U.S. Cl. 340/310.01; 340/310.06

(57) ABSTRACT

A reconditioning system for extending the reach of a RF communication signal using a high voltage cable and a neutral conductor as a communication channel. A reconditioner of the reconditioning system is either a repeater or a regenerator and is coupled to the high voltage cable using novel high voltage couplers. The system has an isolation filter for segmenting the high voltage cable in order to limit interference of RF signals on different parts of the high voltage cable.

### PRIORITY APPLICATION

This application is related to U.S. Provisional Application Serial No. 60/269,191 filed on Feb. 15, 2001, entitled “APPARATUS, METHOD AND SYSTEM FOR RANGE EXTENSION OF A DATA COMMUNICATION SIGNAL ON A HIGH-VOLTAGE CABLE” and commonly assigned to Powercomm Systems, Inc., and incorporated by reference herein, with priority claimed for all commonly disclosed subject matter.

### BACKGROUND OF THE INVENTION

1. Field of the Invention

The present invention generally relates to extending the range of a communications signal and, in particular, to a coupling apparatus and a reconditioning circuit that is utilized to serve as a repeater or a regenerator.

2. Related Art

Conventional analog and digital data communications systems use repeaters and regenerators to extend their range of transmission. For example, repeaters are used in the delivery of cable television and are placed on the cable at intervals of about three thousand feet. To place the repeaters on the cable television line, a coaxial cable, it is necessary to cut the cable and place connectors on the cut ends, and then connect the cable ends to the repeater. Regenerators are used in conventional telecommunication circuits such as T1 circuits. A telephone cable is connected to one side of the regenerator and a second cable to the other side of the regenerator to extend the range of a T1 circuit.

Repeaters are usually needed whenever a communication channel significantly attenuates and distorts a communication signal. The repeater receives a weakened communication signal, amplifies the signal, and then re-inserts a stronger communication signal back onto the communication channel beyond the repeater. In a typical two-way (communication signals in both directions) communication system it is necessary to isolate one side of the repeater from the other side to avoid producing oscillations and interference. The gain of the repeater needs to compensate for the transmission loss between a transmitter and the repeater and between repeaters. A repeater will often add some fixed gain shaping or equalization to compensate for impairments in the channel. Repeaters have limitations, since the amplifiers also add noise so that the signal to noise ratio is reduced with each repeater transition.

Conventional regenerators for data communication signals, for full duplex transmission, use two back-to-back transceivers. When a data communication signal is received by a regenerator, a receiver in the regenerator demodulates the signal to provide a data stream. The data stream is then re-modulated by a transmitter and injected on the next segment of the communication channel. Since the communication signal is regenerated, the noise in the incoming signal is not amplified making it possible to use an unlimited number of regenerators thereby making it possible to extend the reach of a data communication signal to any desired distance.

Power line carrier communication (PLCC) systems have been in operation many years. The conventional PLCC systems were used, for example, to provide communication between distribution substations using a high voltage (HV) cable of a power distribution network. One such system is described in U.S. Pat. No. 3,911,415 of Whyte. The typical voltages on the HV cables of a distribution system are between 4 and 39 kilovolts. The voltage of the communication signal is typically a few volts and in the system of Whyte communication frequencies are approximately between 30 and 400 KHz. with data rates were around 10 Kbps. Repeaters were placed on the line every few miles and frequencies of signals entering the repeaters were shifted to provide different exit frequencies in order to avoid oscillations or interference. For example, a communication signal going in one direction would be received at a frequency f1 then shifted to a frequency f3 before retransmission. Although the Whyte apparatus was not bandwidth efficient, since the frequency f3 could not be used on a line segment that used the frequency f1, the data rates were low and efficiency was not a concern.

At the low data rates and low frequencies used in prior art PLCC systems, communication equipment was compatible with existing power system components of the distribution network. Such components as transformers, power factor correction capacitors, fuses, disconnect switches, circuit breakers, and lightning arresters did not interfere significantly with conventional PLCC systems. However at RF frequencies, typically in the 1 to 200 MHz range, the functional characteristics of these components becomes important in the design of repeaters/regenerators used in an RF PLCC system. For example, an RF communication signal of 40 MHz sees a power factor correction capacitor as a short circuit whereas the capacitor causes only a slight attenuation for conventional low frequency PLCC systems. The RF PLCC system described by Sanderson in U.S. Pat. No. 6,040,759 provides further information on the differences and is incorporated herein by reference. The system of '759 has need for repeaters and regenerators in order to extend its operational range. When a PLCC system operates at RF frequencies such a system can deliver broadband data at rates up to 200 Mbps. It should be pointed out that the HV cable used for data transmission is also used for delivering electrical current from an electrical utility provider to power users and therefore it is not practical, or perhaps impossible, to cut the cable and attach the cut ends to a repeater or regenerator. Hence there is a need for a coupling circuit and reconditioner (either a repeater or regenerator) to extend the range of an RF PLCC system that does not change the power delivery characteristics of the HV cable.

### SUMMARY OF THE INVENTION

Generally, the present invention provides an apparatus for coupling communications signals to and from a high voltage cable for reconditioning by a repeater or a regenerator.

A repeater circuit in accordance with one embodiment of the present invention for a power line carrier communication system is provided where a high voltage cable and a neutral conductor are the communication channel, and where the high voltage cable simultaneously transports low frequency current for power delivery and communication signals for broadband data service, the repeater circuit comprising, a low-pass filter, two RF couplers connected to opposite ends of the low-pass filter, and a repeater connected between the other ends of the couplers. The repeater has amplifiers for boosting the communication signals strength and equalizers for canceling the communication impairments of the high voltage cable.

In accordance with a method embodiment for extending the range of an RF communication system using a high voltage cable and neutral cable as the transmission channel where the high voltage cable is also carrying low-frequency current, the method comprises the step of transmitting over the high voltage cable, an RF signal from a central location downstream towards a remote location. Next the method has the step of splitting the high voltage cable into an upstream RF segment and a downstream RF segment where the segments are RF isolated but low-frequency connected, then receiving the RF signal from the upstream RF segment at a first port of a repeater, followed by directing a reconditioned RF signal from a second port of the repeater to the downstream RF segment of the high voltage cable.

Various features and advantages of the present invention will become apparent to one skilled in the art upon examination of the following detailed description, when read in conjunction with the accompanying drawings. It is intended that all such features and advantages be included herein within the scope of the present invention and protected by the claims.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout several views.

FIG. 1 is a block diagram illustrating a repeater coupled to a high voltage cable.

FIG. 2 is a block diagram illustrating a regenerator coupled to a high voltage cable.

FIG. 3 is a schematic representation of the coupling elements used for the diagrams of FIG. 1 and 2.

FIG. 4 is a block diagram of the repeater shown in FIG. 1.

FIG. 5 is a block diagram of a repeater used for a three phases power distribution system.

FIG. 6 is a modification of the repeater or regenerator of FIG. 1 or FIG. 2 adapted to provide service to multiple branches.

FIG. 7 illustrates a communication system using reconditioners in a variety of locations in a power system in accordance with the present invention.

FIG. 8 illustrates a modified repeater of FIG. 1 adapted to interface with a coaxial cable in accordance with the present invention.

FIG. 9 illustrates the regenerator of FIG. 2 adapted to interface with a customer premise device in accordance with the present invention.

### DETAILED DESCRIPTION OF THE INVENTION

A broadband data communications system operating at RF frequencies has been developed for use over power distribution circuits. The high voltage (HV) cables used in the United States for power distribution networks typically have 4 to 39 kilovolts at a frequency of 60 Hz. and when carrying communication signals in accordance with the present invention also have a few volts of RF signals. The system of the present invention has been described in detail in U.S. Pat. No. 6,040,759 by Sanderson which is hereby incorporated by reference. The system of '759 uses multiple RF channels, frequency division multiplexing (FDM), allowing various modulation methods at different frequencies. Although the preferred modulation method on any of the FDM RF carriers is discrete multitone modulation, or DMT at baseband other modulation methods may be used. Equivalent performance may be obtained with an orthogonal frequency division multiplexing method, or OFDM. However FDM/DMT is the best choice because of its inherent immunity to impulsive noise on the distribution circuit. Further FDM/DMT allows for dynamic frequency allocation of sub-channels on the same distribution circuit. However RF systems, no matter what modulation is used, have limited reach without the use of reconditioners, such as repeaters or regenerators. An RF system utilizing the present invention may deliver data up to 20 miles or more. The operation of the new system at RF frequencies has some unique requirements and constraints that are fulfilled by the new devices disclosed herein.

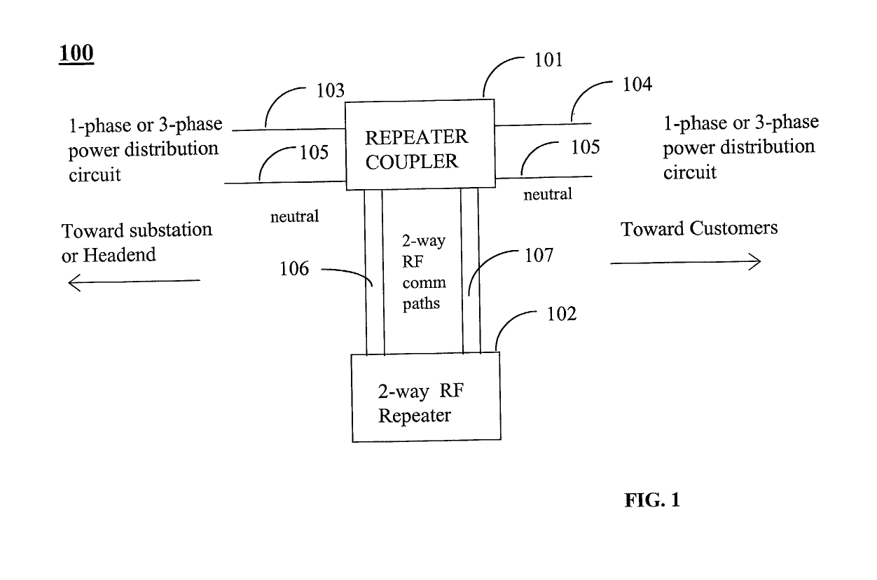

FIG. 1 illustrates a repeater system 100 having a repeater coupler 101 for coupling an RF communication signal (“communication signal”) from a HV cable 103 to a repeater 102 and then back to another section of the HV cable 104. Physically the HV cable 103 and the cable section 104 are a continuous piece of conductor, i.e., there are no physical discontinuities or breaks in the cable and the flow of 60 Hz. electrical current is not impeded. The repeater coupler 101 serves, in part, as a by-directional low pass filter coupled between an input pair of power conductors (103 and neutral cable 105) and an output pair (104, 105). The 60 Hz electrical current flows essentially unconstrained from the input pair 103, 105 to the output pair 104, 105. However the communication signal on the input pair is blocked by the low pass filter function of the repeater coupler 100 and is directed to a first port 106 of a repeater 102 where the communication signal is conditioned and sent out a second port 107 to the second pair 104, 105. The first pair 103, 105, extending towards a headend device, may be referred to as the upstream pair and the second pair 104, 105 extending towards a customer, may be referred to as the downstream pair. The ports extending from the repeater coupler 101 towards the repeater 102 may be referred to as coupling ports. In summary, the upstream pair has a high voltage power current and a communication signal flowing towards the repeater coupler 101. The high voltage power current passes directly through the repeater coupler, whereas the communication signal is directed to the repeater 102 and is then conditioned and sent from the repeater to the second pair. An upstream communication signal, from the customer to towards the repeater coupler, is directed through the repeater in a similar manner. There is essentially no RF energy coupled directly between the upstream pair to the downstream pair. In the descriptions that follow repeaters and regenerators may be one-way or two-way devices.

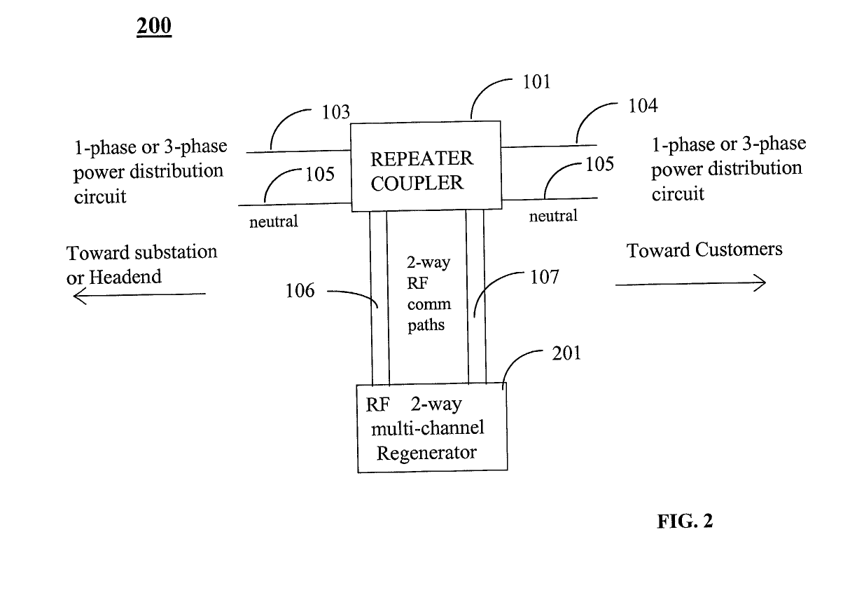

The regenerator system 200 as illustrated in FIG. 2 couples a communication signal to a regenerator 201. The regenerator coupler 101 is identical to the repeater coupler 101 of FIG. 1. The regenerator 201 has characteristics different than those of the repeater 102 as will be described later.

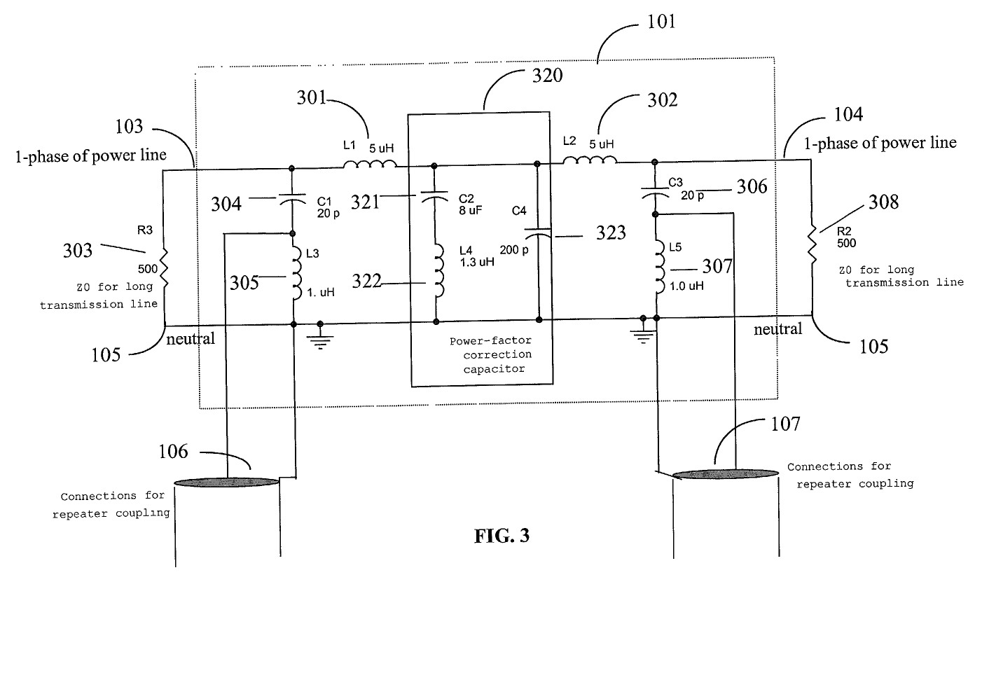

It is important to note that the elements used to provide the filtering and coupling features of FIG. 1 and FIG. 2 are operating in an electrically stressful environment. For example, components used in typical RF devices and in low voltage electronic devices cannot withstand the thousands of voltages on the HV cable. On the other hand, the electrical components normally used on the HV cable are designed to function on 60 Hz. power system and are not generally considered to have characteristics suitable for processing RF communication signals. However, it has been determined that at least two high voltage components, a lightning arrester and a power factor correction capacitor, have characteristics useful for inclusion in the repeater coupler 101. Characteristics of lightning arresters related to RF communications are described in U.S. Pat. No. 5,864,284 by Sanderson and are hereby incorporated by reference. Measurements of the RF characteristics of a power factor (PF) correction capacitor indicate that it can be modeled as a combination of capacitors and an inductor as is shown in FIG. 3.

The repeater coupler 101 of FIG. 2 and 3 is illustrated schematically in FIG. 3. A three element ladder filter comprising a PF correction capacitor 320 and inductors 301, 302 to form a low pass filter. The low-pass filter allows a 60 Hz. current to pass unimpeded from a power distribution station towards a power customer. The inductors are not inline elements, but are ferrites clamped on the HV cable 103, 104. The clamped ferrites provide a high RF impedance and nearly a short circuit to the 60 Hz. power current. The PF correction capacitor 320 is essentially a short circuit to RF communication signals but provides PF correction, its normal use, for the 60 Hz. electrical power system. Because power systems typically have PF correction capacitors installed throughout a distribution system the low pass filter used in the repeater coupler is using a component, the PF correction capacitor 320, for an unintended use and at no cost. A capacitor with the appropriate breakdown voltage and capacitance may be used as a replacement for the PF correction capacitor in the low pass filter and fall within the scope of the present invention.

A series arrangement of a capacitor 304 and an inductor 305 are placed across the HV cable 103 and neutral 105 at a first side (upstream side) of the low pass filter. A similar arrangement using capacitor 306 and inductor 307 is placed on the second side of the low pass filter. The capacitors 304, 306 of the series arrangements are actually lightning arrestors, since measurements have determined arresters have sufficient capacitance to couple RF frequencies. The inductors are ferrites clamped on a cable going from the bottom of the lightning arrester to the neutral 105. At the juncture of the series capacitor 304 or 306 and the inductor 305 or 307 a coupling cable is connected to a reconditioner, such as the repeater 102 or regenerator 201. When the coupling cable goes from the juncture to a coaxial cable, a preferred coupling, the neutral 105 is coupled to the shield of the coaxial cable. The other end of the coaxial cable is attached to the repeater with a conventional connector. The communication channel in the upstream direction from the repeater coupler is represented as a resistor 303 and in the downstream direction as a resistor 308 each having a value of around 500 ohms.

Although the PF correction capacitor 320 and the capacitors 304, 306 (lightning arresters in a preferred embodiment) are elements normally attached to high voltage cables, in the present invention they are used for a purpose for which they were not intended. In addition the ferrites that are clamped on the HV cable are placed on a new structure and used in a new way. Variation in the elements of the preferred embodiment of the repeater coupler 101 that would be apparent to a person skilled in the art fall within the scope of the present invention.

A coupling circuit such as the repeater coupler 101 is needed in order to connect the repeaters and regenerators to the high voltage line. The capacitive property of the lightning arrester also enables it to be used in building filters needed for the repeater or regenerator function of the RF broadband communications system. None of the components of the power distribution circuit, including the lightning arresters, have previously been characterized in terms of equivalent circuit components at RF frequencies. In order to simulate and design the RF PLCC system, equivalent circuit models for distribution circuit components were created based on measurements over the RF frequencies of operation. The devices must be interconnected over large separation distances consistent with the high breakdown voltages that the components must sustain on the high voltage distribution circuit. Because of the large component spacing, element to element radiation effects must be controlled by means of shielded interconnections in order to end up with well-behaved designs at RF frequencies of operation.

FIG. 3 illustrates one combination of circuit elements that has been simulated as a preferred embodiment for the repeater coupler 101, an isolation and coupling device for the repeater 102 or regenerator 201. The combination of measured properties of an actual PF correction capacitor 320, lightning arresters, and ferrites (inductor elements) have been connected as shown in system schematic 300 for a simulation. Since the PF correction capacitor 320 attenuates the RF communication signal, it was determined that it may be incorporated into the repeater coupler to help provide the required isolation loss. Since the PF correction capacitor is a large device and will be cabled across the large, perhaps 4 foot spacing between the power line HV cable and the neutral conductor, it does not have a simple capacitor equivalent circuit at RF frequencies. Instead it has a complex multi-component equivalent circuit model. C2 321, C4 323 and L4 322 arranged as shown in FIG. 3 that is based on measurements. Capacitors Cl 304 and C3 306 are simple capacitive models for lightning arresters used for coupling to the HV cable. Inductors L3 305 and L5 307 are inductive equivalents of ferrite that are clamped to ground conductors to the lightning arresters as described in the coupler of U.S. Pat. No. 5,864,284. The inductors of the low pass filter L1 301 and L2 302 are inductive elements created using ferrites clamped to the HV cable 103, 104 and optionally on the neutral conductor 105, in order to accomplish the isolation filtering (blocking RF from going down the HV conductor) needed for the repeater 102 or regenerator 201.

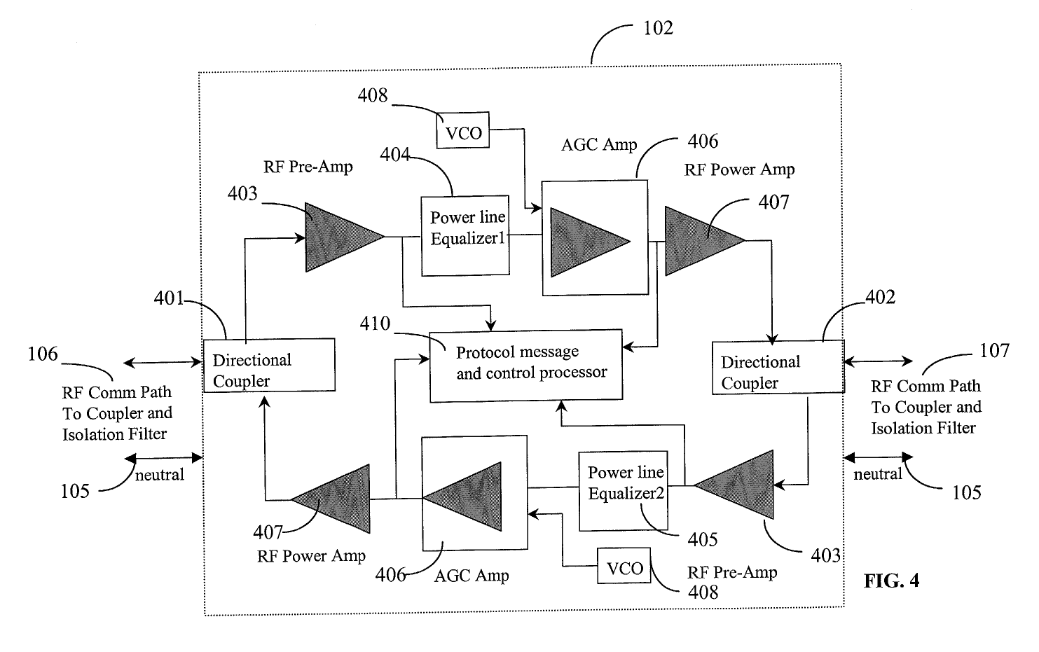

Simulations and subsequent measurements show that the necessary 2-way isolation loss can be achieved for a wide range of repeater spacing along a typical single phase, #2 AWG, 13.8 kv distribution circuit. The PF correction capacitor as modeled provides the original function of PF correction at 60 Hz while operating in the repeater. The long single phase power distribution circuit is simulated by R2 303 and R3 308 on either side of the repeater or regenerator network. The resistors R2 and R3 represent the characteristic impedances of long lengths of the power line distribution circuit. Connections 106 and 107 provide for couplings to the repeater or regenerator devices of the system. The 2-way communications paths, 106 and 107, shown between the repeater coupler 101 and the other part of the unit are preferably coaxial cable in order to maintain the isolation required. The coax cable terminates at the junction of C1 304 and L3 305 in FIG. 3 for the coupling interface toward the substation. Cable 106 has its other end terminated at either a port of the repeater 101 as illustrated in FIG. 4 or at a regenerator port. The other 2-way RF communications path 107, connects to the node between C3 306, and L5 307 of FIG. 3. This provides a connection on the customer side of the repeater coupler 101 from the HV cable 104 to the repeater 102 as shown in FIG. 4 or the regenerator 201 port as shown in FIG. 2. In each case the coax cable shield connection and signal ground reference is preferably with respect to the neutral conductor, 105.

The circuit of FIG. 3 would be duplicated on each of the three phases of the three phase distribution circuit with respect to the neutral conductor for use in a repeater/regenerator operating on the three phase circuit. This will be described further with reference to FIG.s 5 and 6 below.

FIG. 4 shows an embodiment of the internal architecture of the repeater 102, a single-phase 2-way device. For each direction the architecture incorporates directional coupler, 401 or 402, equalizer, 404 or 405, RF pre-amplifier 403, AGC amplifier 406, and an RF power amplifier 407. Also included is a protocol message and control processor 410 that will be examined in more detail shortly. The repeater comprising the combination of elements 403, 406, and 407, provides enough gain in each direction to offset the losses of the channel sections either side of the location of the repeater. For example, if the repeater were located about one mile from the nearest transmitters, then for the band of frequencies from about 5 MHz up to about 50 MHz, the repeater needs a gain of about 35 dBs. to compensate for transmission losses. For the same situation, if the band of frequencies from about 50 MHz up to about 88 MHz is used in the reverse direction, then a gain of about 55 dB from the repeater would be needed to completely compensate for the losses. Frequency shaping of the gain, or equalization, would be provided by 404 or 405, so that all frequencies would be re-transmitted with approximately equal power densities in each direction.

FIG. 4 also shows that the protocol message and control processor 410 that makes voltage measurements out of the RF pre-amplifier 403 and out of the AGC amplifier 406 in each direction. The processor 410 also controls the voltage controlled oscillators, VCOs, 408 in each direction. The VCOs 408 allow signals of variable frequencies to be delivered to the power line under control of the processor. This enables the transmission and SNR measurements needed to optimize system choice of channels and performance.

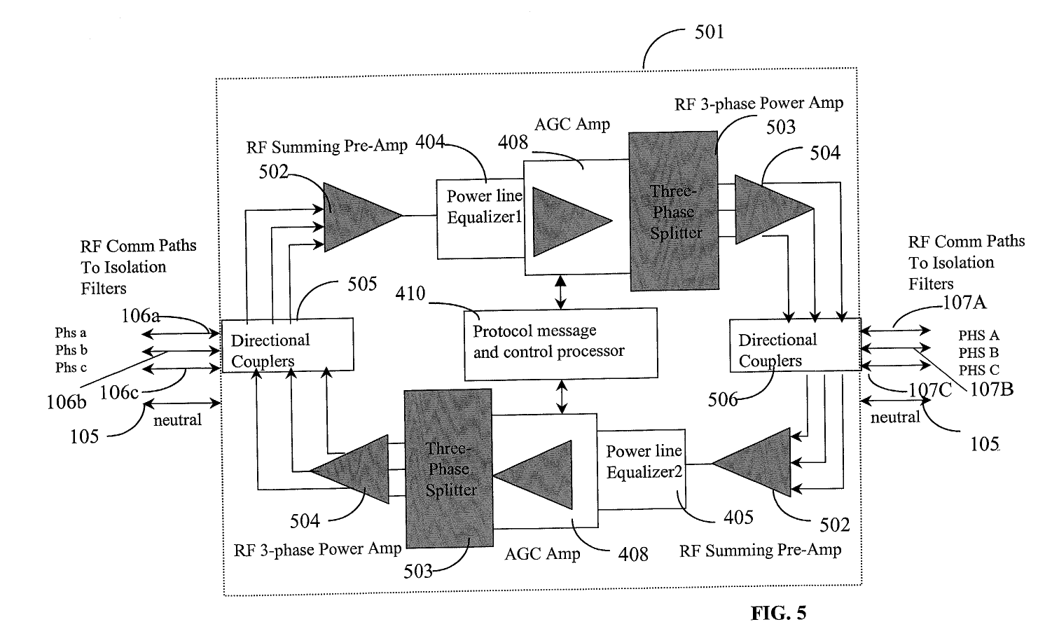

FIG. 5 shows some of the additional complexity needed for operation of a repeater for a three-phase power distribution system. Three isolation and repeater couplers 101, such as illustrated in FIG. 3, are needed to interface with the 3-phase repeater 501, of FIG. 5. Each of the three repeater couplers are placed onto one of the 3-phase power cables. The repeater coupler that is used on the phase A conductor, with respect to the neutral conductor, 105, has its 2-way RF communications ports, 106a and 107A, connected to the Phase A terminals of the 3-phase repeater 501.

Likewise the repeater coupler that is used on the phase B conductor, with respect to the neutral conductor, 105 has its 2-way RF communications ports, 106b and 107B, connected to the Phase B terminals of the 3-phase repeater, 501. Similarly, the repeater coupler that is used on the phase C conductor, with respect to the neutral conductor, has its 2-way RF communications ports, 106c and 107C, connected to the Phase C terminals of the 3-phase repeater, 501. The three communications signal paths from the headend side of the repeater couplers are connected to the directional coupler 505 of the 3-phase repeater 501. The directional coupler 505 contains filters that pass the signal from the headend direction toward the 3-phase RF Summing Pre-amplifier 502. The output of the summing pre-amplifier is fed in the downstream direction to power line equalizers 404. One important aspect of the three-phase repeater is the generation of the output signal from the three-phase power amplifier 504. The three outputs could be identical as they drive the three high voltage couplers. Optionally the three signals could constitute a balanced three-phase set of signals. The advantage of driving the three power lines with the balanced three phase RF signals is that higher drive voltages can be used without producing excessive radiation of the signals. This is true because the balanced three-phase RF fields would tend to sum to zero near the transmitter. Optionally the three signal outputs could be adaptively adjustable in amplitude and phase to minimize the radiation from the power line near the transmitter.

The repeater or regenerator also performs several important control and diagnostic functions to enable the PLCC system to operate efficiently. For example, the repeater or regenerator, contains a protocol message and control processor 410 as shown in FIG.s 4 and 5, that:

1) obtains its initial IP address definition via download from the headend control unit,

2) measures the noise across the frequency spectrum of its useable band and store this information,

3) cooperatively measures transfer gains versus frequency of the distribution circuit between itself and the nearby system node, i.e. devices such as its next nearest neighbor repeater/regenerator or the headend control unit,

4) records SNR margins for all channels in its operation frequency range,

5) reports any inadequate SNR margins to the headend control unit as they occur,

6) performs digital signal processing ( DSP) functions as needed.

7) records errored seconds and BER if a regenerator is used for some number of fixed intervals to guarantee quality of service,

8) monitors all recovered data for TCP/IP messages that might be directed to it, and

9) reports stored parameters on demand to a headend master control unit.

Since the power line distribution network is typically structured with branching circuits and loads, the communications signal undergoes very complicated phase distortions much like those occurring on telephone lines due to “bridged taps”. Much of this phase distortion may be avoided if the power line distribution circuit is compensated, or impedance matched, by placement of RF isolation devices at all branch circuit locations and at load connection points along the circuit as described in the '759 of Sanderson. An automatic equalizer within the repeater or regenerator as an optional element also addresses this problem.

Another possibility for addressing the multiple reflection environment of the power distribution circuit as a communications channel would be to apply the special signal processing as described in U.S. Pat. No. 6,144,711 by Raleigh, et. al, into both the modems at either end of a communications link and also within the regenerators. The Raleigh invention takes advantage of the multiple transmission paths to increase channel capacity but at the cost of significant digital signal processing in the modems, as well as in the regenerators of the RF communication system. The singular value decomposition of by Raleigh may optionally be replaced by an autoregressive decomposition as described in the 1982 PhD dissertation by Sanderson, “A Power Spectral Decomposition Method and Applications”. The Sanderson method provides a less DSP intensive algorithm for providing orthogonalization of the decomposed data segments attributed to each of the major reflection paths of the communications links. Reduction of the reflections as aforementioned is a first step for improved performance but must be followed by a tradeoff between cost of implementation and channel capacity improvement.

Restoring multiple RF channels in each direction along the power distribution network, with each of the multiple channels allowed to contain signals of different RF modulation or different baseband modulation, implies that the regenerator contains some powerful signal processing capability. For each channel in operation through the regenerator, a full transceiver operation is performed. First, selective filtering or tuning is provided to select the signal channel to be processed. After conversion from RF to baseband, all modem functions such as AGC, equalization, timing recovery, symbol decisions, trellis decoding, and forward error correction decoding are executed to recovered data. The recovered data is fed to a transmitter with all operations required of modems and results in a baseband signal. The baseband signal is then upconverted to the appropriate carrier frequency for re-transmission. Alternatively, for some channels the data may be directly modulated onto an RF carrier for example in the case for QPSK modems. The RF modulated carriers for the various channels is then summed and applied to an RF power amplifier 407 or 504. Although regenerator typically cost more than repeaters, regenerator provide better performance whenever the system noise pickup over a segment is very strong and it is desirable to isolate the noise from the rest of the system. At some locations it may be necessary to utilize combinations of both repeaters and regenerators for operation over different portions of the RF band.

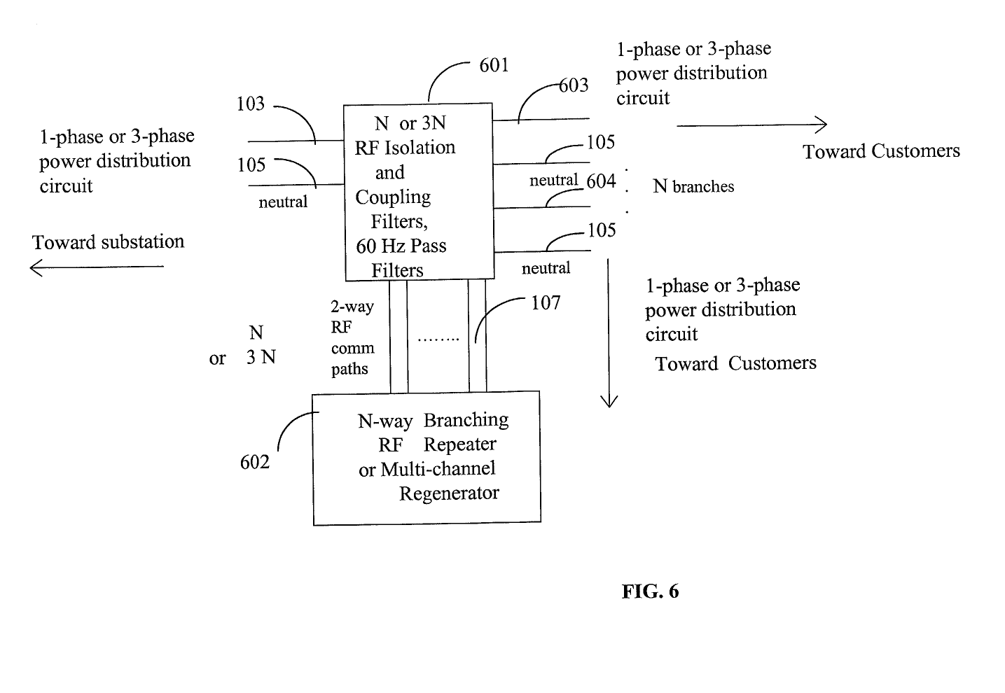

Another use for the repeater coupler 101 and the reconditioner, either the repeater or the regenerator, is for coupling a main feeder distribution circuit to lateral or branch circuits as illustrated in FIG. 6. The main distribution circuit, shown as HV cable 103 and neutral 105, often separates into branch circuits at road intersections or at concentrations of residences. Hence the PLCC system must branch in order to provide communications to all power customers on the power system branches. The branch circuits extending from the main feeder distribution circuit may be three phase or single phase using any one or all of the three phases. In another case the branch circuit may be a Tee with branches going off in two or more directions and with the main distribution circuit continuing. With the mentioned cases the reconditioners have sufficient amplifier power outputs to drive each of the branch circuits. For the upstream direction, the reconditioner has separate equalization and amplifier summing inputs in order to combine the signals into a common output signal directed toward the headend. The repeater system structure 600 to supply branch circuits 603 105, 604 105 comprises an N repeater coupler 601 having N coupler ports to an N way reconditoner 602. Modifications may be made to adapt to 3N systems (for 3 phase distribution) that would be understood by someone skilled in the art. The N way reconditioner is comprised of a combination of repeaters and regenerators to meet the specific branch circuit requirements. characteristicsfor this application is created to work across all combinations of inputs to outputs connected to the conditioner.

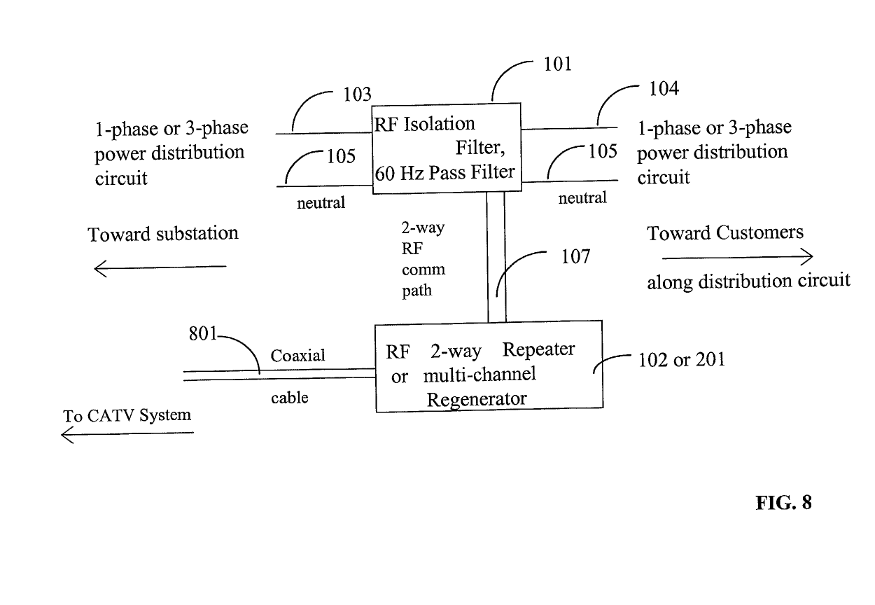

The reconditioning system of the present invention in another embodiment is used as a segmentation device for splitting a distribution circuit into independent segments over which separate PLCC systems operate as illustrated in FIG. 8. A coaxial feeder 801 provides two-way RF communication signals to a reconditioner, such as a repeater 102 or a regenerator 201. The regenerator then couples, using two couplers, the two-way RF reconditioned signal to a the repeater coupler 101. The coaxial feeder 108 is used for coupling CATV in another embodiment.

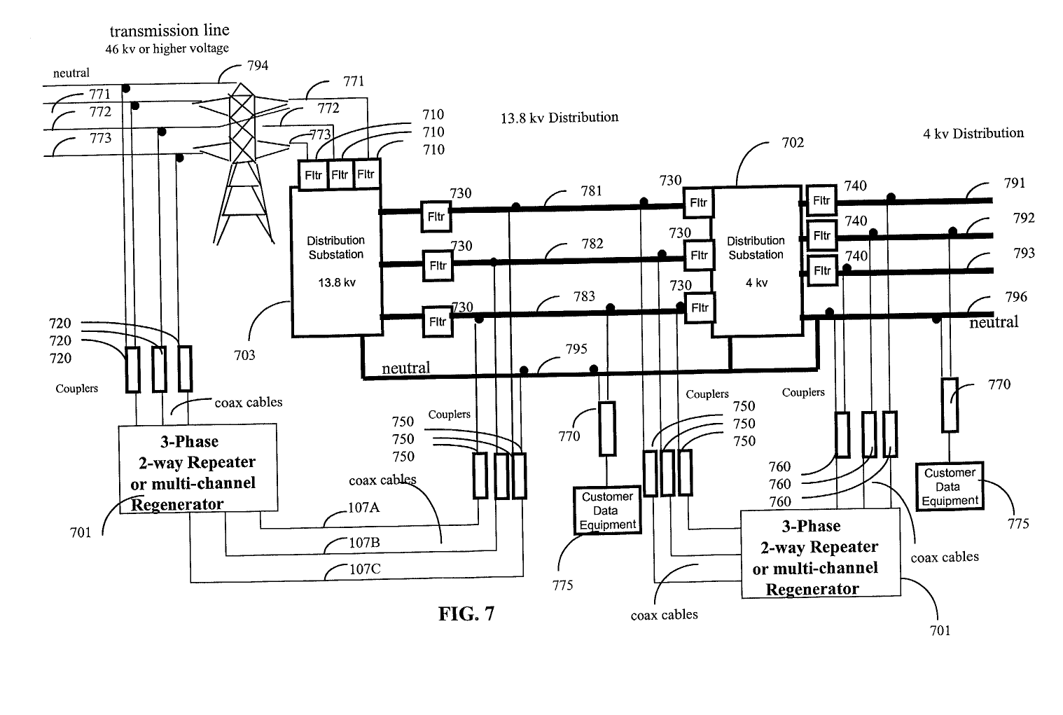

Another use of the reconditioner system 100 is to bridge from a distribution circuit operating at a first HV level voltage level to another operating at a different HV level as illustrated in FIG. 7. For example, the RF communications system is deployed with a headend (not shown) at a 13.8 kv substation 703, that along its length feeds a step down transformer to a 4 kv substation 702. The reconditioner structure is then used to continue the communications system onto the 4kv distribution circuits 791, 792, and 793. Likewise, the reconditioner structure described herein couples or bridges the RF communication signal to a very high voltage transmission line having VHF cables 771,772, and 773, operating at 46 kv or higher voltage, feeding power to a substation, 703 and its distribution circuits 781,782,and 783. In each case the components required in the couplers 720, 750, 760 and 770, and in the isolation filters 710, 730, and 740, must be selected to sustain the high voltage of the power circuit where they are used. In FIG. 7 all connections between the coupler circuits and the repeater devices are coaxial cable in order to minimize radiation effects with the shields tied to the neutral conductors 794, 795 and 796. Protection devices of appropriate rating must be used for safety at the higher voltage ports to prevent the higher voltage from appearing at the lower voltage port of the repeater.

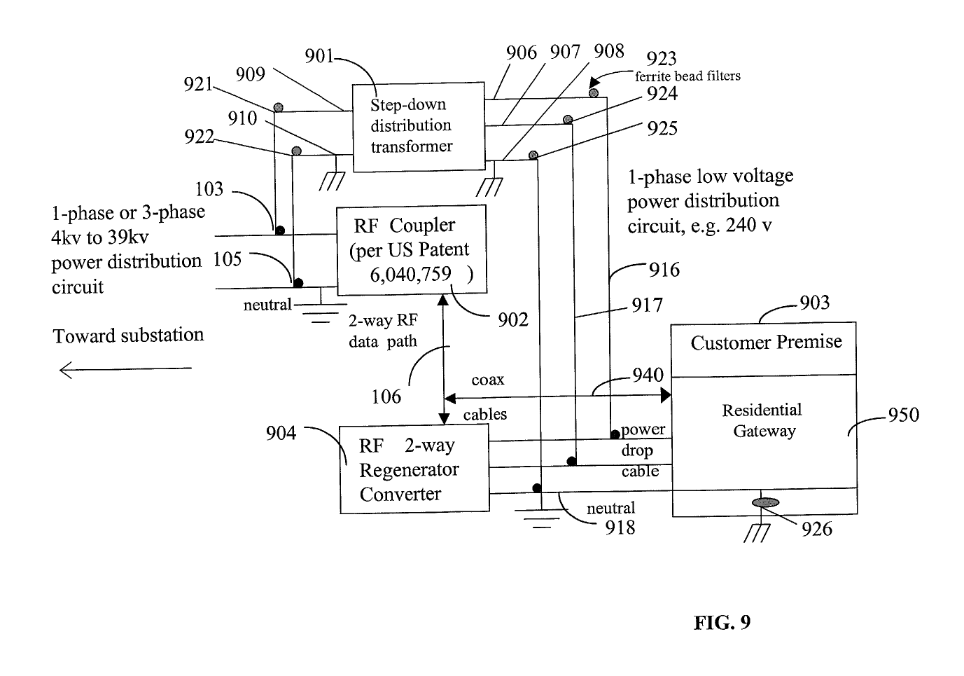

The preferred method of interfacing to a customer premise 903 is illustrated in FIG. 9. A coaxial cable 940 is attached to RF coupler 902, as described in patent '759, and provides a low loss connection for two-way communication. More elaborate interface such as a residential gateway 950 may also be coupled to regenerator 904 as an alternative connection method. The residential gateway 904 also provides for several alternative interfaces for information to be switched and distributed within the residence, for example onto the in-house power lines, telephone lines or coaxial cable. Whether connected by the coaxial cable 940 or by a low voltage power cable 916, 917 and 918 the RF PLCC system is terminated through a residential gateway, which completes the broadband data connection and makes it available for access within the residence to devices such as a telephone line based LAN or existing coaxial cable within the residence.

A further use for the regenerator 904 described here is as a converter 904 for connection from the high voltage power line 103 to the lower voltage power line that drops into the customers premise 916,917 and 918 as shown in FIG. 9. Whereas the high voltage distribution circuit is operating at voltages from 4 kv to about 39 kv, the voltage delivered into the premise is stepped down by a transformer 901 to 600 volts or 240 volts. The lower voltage power cables 906,907and 908 are used as a transmission line along with the extensions 916, 917 and 918 for the RF communications delivery into the premise directly onto the in-house wiring. This is done with realization that the low voltage drop cable will have limited frequency spectrum useable and also has the possibility of radiating the RF communications signals. This connection uses frequencies in the range of from 1 to 40 megahertz. However, this provides a cost effective coupling for providing a lower data rate interface for functions such as automatic power meter reading and communications with devices attached to the in-house wiring. The converter 904 may need to translate the signals used by the broadband PLCC system on the high voltage line to those used internally to the residence. For example, the residence may have an in-house power line LAN, such as that defined by the HomePlug Alliance. The frequencies of operation for HomePlug Alliance system are limited to the range of about 4.5 MHz to about 21 MHz. And the modulation method is OFDM. For direct compatibility with the HomePlug Alliance system the PLCC system operating on the HV distribution circuit sets aside these frequencies and uses the same modulation method and directly interface with the in-house LAN over either the coax interface or the low voltage cable interface. If these frequencies are not directly usable over the distribution circuit or the individual carriers cannot be efficiently utilized with the same number of bits per Hertz in both channels there a frequency translation is made in order to allow the PLCC system on the high voltage line and the in-house communications system to be compatible. The regenerative converter of the present invention is adapted to solve this problem as well as many others.

In FIG. 9 ferrite beads 921, 922, 923, 924, 925 or are placed on the leads of the step-down transformer in order to isolate RF signals from passing through the transformer. The ferrites beads are used because power transformers have low pass characteristics. Ferrites 921, 922 on the high voltage side 909 of the transformer 901 are helpful in impedance matching the transformer as a load on the HV cable for improved performance for the broadband communication system as previously described in patent '759. Three of the ferrite beads 922, 925 and 926 serve to isolate the neutral conductor, that serves as the reference potential for the RF communications signals, from the earth ground. The ferrites raise the impedance for RF signals above earth ground and inhibits RF communications signals from flowing to the earth and thereby decreases radiated emissions.

The communications over the low voltage drop cable 916, 917,and 918 into the residence could best be performed by means of DMT or OFDM modulations using frequencies compatible with channel characteristic for both the high voltage distribution circuit 103 and 105, and also for the low voltage drop cable 916, 917 and 918 to the customer premises. This would allow an in-house LAN, such as defined by the HomePlug Alliance. Alternatively, the repeater/regenerator used in this embodiment might optionally also incorporate frequency translation for the communications between the high voltage distribution circuit and the low voltage drop cable. The frequency translation could also be from those used on the high voltage power line to an acceptable RF wireless communications frequency. New standards for broadband communications over short distance could be used, for example in the unregulated 2.4 GHz or 5. GHz carrier bands as described in the IEEE 802.11 standards that are being used for wireless LANs. The regenerative converter 904 could alternatively convert between the PLCC system signals and the IEEE 802.11 communications signal methods and provide a wireless interface from the power pole into the premises. The customer premise 903 would need to contain an interoperable IEEE 802.11 transceiver for the converter to communicate with.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

I claim

1. A method for extending the range of an RF communication system using a high voltage (HV) cable and neutral cable as the transmission channel, where the HV cable is simultaneously carrying low-frequency current, the method comprising the steps of:
transmitting over the transmission channel, an RF signal from a central location downstream towards a remote location;
splitting the HV cable into an upstream RF segment and a downstream RF segment where the segments are RF isolated and low-frequency connected;
receiving the RF signal from the upstream RF segment at a first port of a reconditioner;
directing a reconditioned RF signal from a second port of the reconditioning device to the downstream RF segment of the HV cable.

2. The apparatus of claim 1 wherein the RF isolation is provided by a low pass filter comprising blocking inductors and at least one capacitor for RF attenuation.

3. The apparatus of claim 1 wherein the reconditioner is a repeater.

4. The apparatus of claim 1 wherein the reconditioner is a regenerator.

5. The apparatus of claim 1 wherein the directing step utilizes a series capacitor and inductor arrangement with a connection going from the juncture of the capacitor and inductor to the reconditioner.

6. The apparatus of claim 1 wherein the steps are adapted for two-way communication.

7. A method for extending the range of an RF communication system using a high voltage cable as the transmission channel comprising the steps of:
forming a first RF segment and a second RF segment of the HV cable;
coupling the segments to ports on a reconditioning device; and
reconditioning RF signals from each of the segments.

8. The apparatus of claim 7 wherein the forming step is provided by a low pass filter.

9. The apparatus of claim 7 wherein the coupling step is provided by a lightning arrester in series with a ferrite clamped on a cable.

10. The apparatus of claim 7 wherein the reconditioning step includes amplification and equalization.

11. The apparatus of claim 7 wherein the reconditioning step is provided by a regenerator having at least demodulation, decoding, encoding and modulation.

12. An apparatus for isolating RF signals in a broadband data communication system having a HV cable and a neutral cable as a communication channel, the apparatus comprising:
a first RF signal on the HV cable;
a second RF signal on the HV cable;
an isolation filter for electrically isolating the first RF signal from the second RF signal, the isolation filter comprising a ladder network of one or more ferrites clamped on the HV cable and one or more capacitors connected between the HV cable and the neutral cable;
RF couplers on each side of the isolation filter for coupling the RF signals to ports of a reconditioner.

13. The apparatus of claim 12 wherein the isolation filter is a symmetric filter.

14. The apparatus of claim 12 wherein the one or more capacitors is a power factor correction capacitor.

15. The apparatus of claim 12 wherein the RF signals are greater than 20 MHz.

16. The apparatus of claim 12 wherein the reconditioner has a processor for monitoring voltage levels within the reconditioner.

17. The apparatus of claim 12 wherein the reconditioner is a two-way repeater.

18. The apparatus of claim 12 wherein the reconditioner is a two-way regenerator.

19. A reconditioning circuit for a PLCC where an high voltage cable and a neutral are the communication channel and where the high voltage cable simultaneously transport low frequency current for electrical power and communication signals for broadband data service, the reconditioning circuit comprising:
a low-pass filter;
two RF couplers connected to opposite ends of the low-pass filter;
a reconditioner connected between the other ends of the couplers, the reconditioner comprising at least amplifiers for boosting the communication signals strength.

20. The apparatus of claim 19 wherein the reconditioner is a two-way regenerator.

21. The apparatus of claim 19 wherein the reconditioner is a two-way repeater.

22. An apparatus for RF by-passing a power factor correction capacitor on a high voltage cable and directing communication signals to a reconditioner, the apparatus comprising:
a plurality of ferrites clamped on the capacitor cable cooupling the high voltage cable to the capacitor; and
couplers connected to the high voltage cable and the reconditioner.

23. The apparatus of claim 22 wherein the reconditioner is a two-way regenerator.

24. The apparatus of claim 22 wherein the reconditioner is a two-way repeater.

25. An apparatus distributing RF communication signals from a HV cable to and from a plurality of branch circuits, the apparatus comprising:
a plurality of low pass filters for RF isolating the HV cable from each of the branch circuits;
a plurality of couplers where one coupler is connected to the HV cable and to each of the branch circuits, and
a reconditioner having a HV cable port and a branch port for each of the branch circuits, the reconditioner having amplifiers and filters for directing and conditioning the communication signals.

26. The apparatus of claim 25 wherein the reconditioner is a regenerator.

27. The apparatus of claim 25 wherein the reconditioner is a repeater.

28. The apparatus of claim 25 wherein the RF frequencies are in the band from 20 MHz to 200 MHz.

29. An apparatus coupling a communication signal from a transmission cable feeding a distribution substation to a distribution cable exiting the distribution substation, the apparatus comprising:
a transmission blocking filter for blocking the communication signal from entering the distribution substation by way of the transmission cable;
a transmission coupler connected to the transmission cable;
a distribution blocking filter for blocking RF energy from entering the distribution cable by way of the distribution cable;
a distribution coupler connected to the distribution cable; and
a reconditioner having ports connected to the couplers, the reconditoner comprising directional couplers and amplifiers.

30. The apparatus of claim 29 wherein the reconditioner is a regenerator.

31. The apparatus of claim 29 wherein the reconditioner is a repeater.

32. An apparatus for coupling a communication signal on an RF coaxial cable to HV cable for upstream and downstream communication, the apparatus comprising:
a low pass filter for isolating the segmenting the HV cable to a downstream side and an upstream side;
a reconditioner having a coaxial port for receiving the coaxial cable and two HV cable ports, and
two couplers for coupling the HV cable ports to each side of the HV cable.

33. The apparatus of claim 32 wherein the reconditioner is a regenerator.

34. The apparatus of claim 32 wherein the reconditioner is a repeater.

35. A repeater for receiving and sending communication signals to an upstream segment and a downstream segment of a HV cable, the repeater comprising:
an arrangement of downstream elements comprising a downstream preamplifier, equalizer, AGC amplifier and power amplifier where the downstream elements receives a downstream communication from the upstream segment and transmits a signal to the downstream segment;
an arrangement of upstream elements comprising an upstream preamplifier, equalizer, AGC amplifier and power amplifier where the upstream elements receive an upstream communication signal from the downstream segment and transmits a signal to the upstream segment; and
direction couplers for directing the communication signals.

36. The repeater of claim 35 further comprising a control processor for monitoring and adjusting signal levels within the repeater.

37. The processor of claim 36 further having a means for transferring information to a headend device.

38. A regenerator for receiving and sending communication signals to an upstream segment and a downstream segment of a HV cable, the regenerator comprising:
an arrangement of downstream elements comprising a downstream demodulator, equalizer, decoder, encoder, modulator and power amplifier where the downstream elements receive a downstream communication signal from the upstream segment and transmits a signal to the downstream segment;
an arrangement of upstream elements comprising an upstream demodulator, equalizer, decoder, encoder, modulator and power amplifier where the upstream elements receive a upstream communication signal from the downstream segment and transmits a signal to the upstream segment; and
direction couplers for directing the communication signals.

39. The repeater of claim 38 further comprising a control processor for monitoring and adjusting signal levels and for determining bit error rates within the regenerator.

40. The processor of claim 39 further having a means for transferring information to a headend device.
